(19) United States
(12) Patent Application Publication
(10) Pub. No.: US 2008/0268398 A1
(43) Pub. Date: Oct. 30, 2008

(54) Differential Archwire

(76) Inventor: Daniele Cantarella, Nervesa (IT)

Correspondence Address: INDIANO VAUGHAN LLP, ONE N. PENNSYLVANIA STREET, SUITE 1300, INDIANAPOLIS, IN, 46204, US

(21) Appl. No.: 12/137,381

(22) Filed: Jun. 11, 2008

Related U.S. Application Data
(63) Continuation-in-part of application No. PCT/IT2006/000803, filed on Nov. 17, 2006.

(30) Foreign Application Priority Data
Dec. 12, 2005 (IT) TV2005A000194

(51) Int. Cl. A61C 7/20

(52) U.S. Cl. 433/20

(57) ABSTRACT

An archwire is disclosed for use in an orthodontic appliance of the type that includes brackets attached to a surface of at least one tooth. The archwire includes an anterior portion for engaging at least one bracket of at least one anteriorly disposed tooth in a patient's mouth. The anterior portion includes a relatively larger cross sectional area, a first end portion and a second end portion. A first posterior portion is provided for engaging at least one bracket of at least one posteriorly disposed tooth in a patient's mouth. The first posterior portion includes a proximal end portion fixedly coupled to the first end portion of the anterior portion, and a second end. A second posterior portion is provided for engaging at least one bracket of at least one posteriorly disposed tooth in a patient's mouth. The second posterior portion includes a proximal end portion fixedly coupled to the second end portion of the anterior portion of the second end. The first and second posterior portions each have a relatively smaller cross sectional area than the relatively larger cross sectional area of the anterior portion.

### REFERENCE TO RELATED APPLICATIONS

This application is a continuation-in-part of International Application No. PCT/IT2006/000803, filed 17 Nov. 2006; this application claims priority to International Application No. PCT/IT2006/000803, filed 17 Nov. 2006 which itself claims priority to Italian Patent Application No. TV2005A000194, filed 12 Dec. 2005 both of which are incorporated fully herein by reference.

I. Technical Field of the Invention

The present invention relates to orthodontic appliances, and more particularly to an archwire to be utilized as a component of fixed orthodontic appliances.

II. Background of the Invention

It is known that orthodontic appliances are utilized to move teeth along the three planes of the space inside a mouth. Fixed orthodontic appliances include a series of brackets glued to the teeth. Archwires are secured in slots that are usually formed as a part of the brackets. Brackets having slots with a rectangular cross-sectional shape are called “edgewise”, and are the type of bracket used most frequently today. The forces used to move the teeth are generated by coil springs or elastic chains attached to the brackets, or by closing loops modeled on the archwires.

In many phases of an orthodontic treatment, it is necessary to move the incisors of the upper dental arch posteriorly toward the rear of the mouth. This movement is often encountered in the final phase of the treatment of second class type malocclusions characterized by the tact that the upper dental arch is positioned too far mesially in relation to the lower dental arch. The distalizing class I force used to move the upper incisors backwards is generated by elastic chains or coil springs running from the molars to the incisors, or by closing loops modeled on the archwires.

At the present time there are two techniques used to move the incisors in a rearward (posterior) direction toward the molars. The two techniques include techniques that utilize sliding mechanics; and techniques that utilize non-frictioning mechanics. Sliding mechanics is the basis of the “straight wire technique”. In the known prior art, an archwire with constant cross-sectional size is utilized on all teeth. Slots of the brackets have the same cross-sectional dimension on all teeth. A rearward force (from the incisors toward the molars) is generated by elastic chains or coils running from the incisors to the molars. As the incisors retract rearwardly, the archwire slides rearwardly through the slots of the brackets of canines, premolars, molars. In order for this technique to work well, it is important to choose an archwire having the proper cross sectional size. An archwire with a relatively small cross-sectional size slides well along the brackets of posterior teeth, but it gives little or no control to the bucco-lingual inclination of the incisors during their retraction. In fact, small cross sectional wires often have too much space (play) within the slot and are free to rotate inside the slots of the brackets of the incisors. As a consequence during the retraction, incisors rotate around a center of resistance 51 placed at the apical third of the root, and become more upright. This type of undesired movement is often referred to as a rotational type movement, since the incisor rotates about its center of resistance. Such rotational movement of the incisors is usually not desired, since it results in the lower portions of the upper incisors contacting the lower incisors, which thereby interferes with the user's bite. (FIG. 5).

On the other hand, an archwire with relatively large cross-sectional size tends to give good control to the bucco-lingual inclination of the incisors during their retraction. However, it generates too much friction on the slots of the brackets of the posterior teeth, hampering the sliding of the archwire along the brackets of posterior teeth.

The “Bi-dimensional technique” utilizes sliding mechanics, and has been introduced with the aim to solve the above-cited problem. In the “bi-dimensional technique”, the size of slots of the incisor brackets are different than the size of the slots used on the brackets attached to the canines, pre-molars (bi-cuspids) and molars. The brackets of the incisors have cross-sectional size 0.018 by 0.025 inches (0.45720 by 0.63500 mm), and the slots of the brackets of canines, premolars and molars have cross-sectional size 0.022 by 0.028 inches (0.55880 by 0.71120 mm). The archwire typically used to retract the incisors has cross-sectional size 0.018 by 0.022 inches (0.45720 by 0.55880 mm).

This archwire fills completely the slots of the incisor brackets assuring good control of the bucco-lingual inclination (torque) of the incisors during their retraction. At the same time this archwire with a cross-sectional size of 0.018 by 0.022 inches (0.45720 by 0.55880 mm) does not come close to filling all of the available space within the slot, and thereby has a lot of play inside the slots of the brackets of the canines, premolars and molars, assuring low friction and good sliding of the wire along these brackets.

The main drawback of the “bi-dimensional technique” is that the thickness of the archwire that can be utilized is limited to a cross-sectional size of 0.018 by 0.022 inches (0.45720 by 0.55880 mm). This limitation exists because the archwire must fit into slots of the brackets of the incisors that have a height of 0.018 inches (0.45720 mm). Unfortunately, an archwire of such limited size cannot control the bucco-lingual inclination (torque) of the posterior teeth (canines, premolars, molars), which is important in other phases of the orthodontic treatment (for example during the repositioning of impacted canines or during the up-righting of linguo-inclined molars).

In U.S. Pat. No. 6,811,397, Wool describes an orthodontic archwire characterized by an anterior segment and two posterior segments. The anterior segment has a rectangular cross-section, for providing a good control of the bucco-lingual inclination of the incisors. The two posterior segments have a round cross-section. The round cross section is used to reduce the friction between said posterior segments and the slots of the brackets of the posterior teeth to thereby facilitate the sliding of the posterior portion in the slots.

The archwire described by Wool presents anterior and posterior segments with substantially the same flexural rigidity. Wool, in the detailed description of the invention, writes that “flexural rigidity is used herein in the same manner as in U.S. Pat. No. 4,412,819 to Cannon, i.e., in a conventional sense as defined by Young's module of elasticity times the second moment of inertia of the cross-section. By the term “substantially the same” applicant generally means flexural rigidity which is either identical or varies only to such an extent that the difference has no material effect on the treatment. For example, due to manufacturing tolerances, the segments, even if made nominally of the same alloy, might have slightly different flexural rigidity if manufactured at different times. The term “substantially the same flexural rigidity” is intended to cover different pieces made of nominally the same alloy but, due to manufacturing tolerances, having slightly different (e.g. within a range of 1-3%), flexural rigidity”.

One drawback of Wool's archwire design is that the flexural rigidity of anterior and posterior segments is the same.

Contrary to Wool's teachings, the applicant has surprisingly found that during incisor retraction, it is preferable that the anterior segment 11 of the archwire has higher flexural and torsional rigidity than the posterior segments 12, 13. During incisor retraction higher flexural and torsional rigidity is required in the anterior segment 11, to better control the mesio-distal inclination (tip) and the bucco-lingual inclination (torque) of the incisors.

On the other hand, lower flexural and torsional rigidity is required in the posterior segments 12,13 of the differential archwire, because lower flexural and torsional rigidity greatly reduces binding of wire to brackets of canines, premolars, molars, making incisor movement backwards in a translational manner much more efficient. The relationship between wire rigidity and wire-bracket binding will be discussed below in this patent application in paragraphs 96 through 114.

In his patent German patent entitled “Torque-Bogen”, number DE4419471A1, Forester describes an archwire with a non-circular cross-section characterized by an anterior segment constituted by super-elastic material and possessing a torsional component. The purpose of the torsional component is to increase the torque of the roots of the incisors towards the palate, during the retraction of the incisors. The main drawback of the loerster design is that the anterior segment that is composed of a super-elastic material, does not generate enough rigidity of the archwire along the horizontal plane. As a consequence, the forces used to move the teeth backwards cause a rotational pivoting of the teeth towards the side of the tongue, rather than the desired translational movement of the teeth.

Chikami European Patent Application No. EP 1 092 398 A describes an orthodontic wire. However, this wire is to be utilized as a retainer wire, and is a removable appliance. It is not utilized as part of fixed orthodontic appliances, and does not engage any slots or any brackets. Also, the posterior portions of the wire described by Chikami have round cross-section shape. The drawback of the round cross-section shape is that it doesn't generate enough rigidity of the wire along the horizontal plane. For this purpose the rectangular cross-section shape with the long dimension of the rectangle parallel to the horizontal plane (i.e. perpendicular to the plane of the buccal surface of the tooth) works much better.

Non-frictioning mechanics utilize closing loops modeled on the archwire in a position distal to the lateral incisors (see, for example, Hilgers, U.S. Pat. No. 5,131,843). The archwire is positioned in the slots of the brackets, and the part of the archwire that is behind (distal to) the bands of the molars is pulled backwards and blocked with a 90 degree bend from sliding forwardly out of the slots of the brackets, thus effectively locking the archwire into the slots. This way the closing loop is opened and activated. Because of the elasticity of the material that constitutes the archwire, the closing loop tends to close itself and to pull the incisors backwards. The archwire that is utilized has a large cross-section size in order to fully engage into the slot of the brackets and to control the bucco-lingual inclination of the incisors.

The problems associated with the closing loops are that the loops can irritate the cheeks and that they tend to trap food and plaque. Furthermore, the activation of the loops and the removal of the archwire require a procedure that consumes a large amount of the dentist's time, as the archwire must be either cut or “unbent” in order to be removed.

One object of the present invention is to provide a “differential archwire”, characterized by an anterior segment 11 with a large cross-section area, and by two posterior segments 12, 13 having a smaller cross-section area (FIGS. 1, 2, 3, 4) for achieving both better buccal-lingual control of the incisors, while providing good slidability of the posterior sections in the bracket slots.

Preferably, the “differential archwire” can be utilized in association with pre-adjusted brackets today available on the market and commonly used in the orthodontics practice today. The shape of the cross-section of the anterior segment and of the posterior segments of the archwire is preferably, but not necessarily rectangular with the long side of the rectangle placed along the horizontal plane. The archwire should be sized to fit within bracket slots that are generally similar to the brackets used with all of the bracket-containing teeth.

### SUMMARY OF THE INVENTION

In accordance with the present invention, an archwire is disclosed for use in an orthodontic appliance of the type that includes brackets attached to a surface of at least one tooth. The archwire comprises a bio-compatible wire that includes an anterior portion for engaging at least one bracket of at least one anteriorly disposed tooth in a patient's mouth. The anterior portion includes a relatively larger cross sectional area, a first end portion and a second end portion. A first posterior portion is provided for engaging at least one bracket of at least one posteriorly disposed tooth in a patient's mouth. The first posterior portion includes a proximal end portion fixedly coupled to the first end portion of the anterior portion, and a second end. A second posterior portion is provided for engaging at least one bracket of at least one posteriorly disposed tooth in a patient's mouth. The second posterior portion includes a proximal end portion fixedly coupled to the second end portion of the anterior portion of the second end. The first and second posterior portions each have a relatively smaller cross sectional area than the relatively larger cross sectional area of the anterior portion.

In a preferred embodiment of the present invention, the cross sectional areas of each of the anterior portion, first posterior portion and second posterior portion include a width dimension extending in a direction generally perpendicular to a plane of a surface of a tooth to which a bracket is attached, and a height dimension extending in a direction generally parallel with the plane of a surface of a tooth to which a bracket is attached. The width dimension of the cross sectional areas of each of the anterior portion, first posterior portion and second posterior portion is greater than the height dimension of the corresponding anterior portion, first posterior portion and second posterior portion

A first intermediate portion is also provided. The first intermediate portion is positioned at the connection point between the first posterior portion and the anterior portion. A second intermediate portion exists in the area where the second posterior portion is fixedly coupled to the anterior portion. The cross sectional area of the first and second intermediate portions is greater than the cross sectional areas of either of the posterior portions or anterior portion, and the flexural rigidity of the intermediate portion is greater than the flexural rigidity of either the anterior portion or posterior portions.

Additionally, the anterior portion preferably includes a first end portion and a second end portion; and each of the first and second posterior portions also include first end portions and second end portions. The first end portion of the anterior portion is overlappingly fixedly coupled to the proximal end of the first posterior portion to form the first intermediate portion. The second end portion of the anterior portion is fixedly overlappingly coupled to the proximal end of the second posterior portion to form the second intermediate portion. Preferably, the anterior portion and posterior portions each have a cross sectional shape that is chosen from a group consisting of ovals, ellipses, quadrilaterals, pentilaterals, hexilaterals, spetilaterals and octilaterals, with the most preferred shape being that of a rectangular cross section area. The first and second posterior portions preferably have a sufficiently small cross sectional area in relation to the brackets (and more particularly in relation to the slots of the brackets) to permit the first and second posterior portions of the archwire to slidably move relative to the bracket with only minimal frictional resistance. By contrast, the cross sectional area of the anterior portion is preferably sufficiently large relative to the brackets to induce a torquing force on a tooth to which the bracket is attached. This ability to induce a torquing force enables the anterior portion, and hence the archwire to influence the inclination of a tooth (such as an incisor) and to not be slidably movable relative to the bracket without overcoming a greater amount of frictional resistance than that which exists between the first posterior portion and the bracket.

One feature of a most preferred embodiment of the present invention is that a rectangular cross sectional area archwire is used wherein the width dimension of the cross sectional areas of each of the anterior portion, first posterior portion and second posterior portion is greater than the height dimension of the corresponding anterior portion, first posterior portion and second posterior portion. Such a rectangular longer width configuration has several advantages. First, the forces that are utilized to close the spaces present in the dental arch are exerted over a semicircle. Hence, these forces have a centripetal component, and they tend to push the teeth towards the side of the tongue and to generate a decrease of the transverse diameter of the dental arches. The component that resists these centripetal forces is given by the rigidity of the archwire along the horizontal plane.

For this reason it is preferable to use an archwire with rectangular cross-section with the long side of the rectangle parallel to the horizontal plane. This shape of the cross-section of the archwire guarantees a higher rigidity of the archwire along the horizontal plane (better than the round cross-section), and helps to maintain a correct transverse dimension of the dental arch during incisor retraction, and space closure in general.

Also, en-masse retraction of incisors-canines with the use of mini-screws generates rotational moments that tend to push the upper molars towards the side of the palate, creating a lateral cross-bite. Rectangular cross-section guarantees a higher rigidity of the archwire along the horizontal plane (better than the round cross-section), and helps to maintain a correct transverse dimension of the dental arch.

A second reason that a rectangular cross-section shape is preferred over the round cross-shape, is because when second order bends (either V-bends for incisor torque control, or step up bends for control of vertical position of incisors) are made on the archwire, the wire deflects and a force is generated at the wire-bracket interface of the canine, creating wire-bracket binding phenomena. This force tends to push the archwire against the edge of the canine bracket. With round wires, the bracket of the canine can bite into the round wire (FIG. 32A), making the wire surface rough and hampering sliding mechanics. With rectangular wires the force is exerted over a larger surface, that is the entire bucco-lingual width of the rectangle, resulting in less pressure and this “biting” effect doesn't occur (FIG. 32B). This is in agreement with the finding of Frank and Nikolai that an 0.020 round wire is associated with more friction than the 0.017×00.25 rectangular wire when 2^{nd} order wire-bracket angulations exist (Frank C A, Nikolai R J: A comparative study of frictional resistances between orthodontic bracket and archwire. Am J Orthod 78:593-609, 1980).

As shown in FIG. 32A, when wires are deflected, the edge of the canine bracket generates a high pressure that can permanently deform (notch or bite into) a round wire. The large vertical arrow indicates that the force is exerted in one point only of the round wire, resulting in a large pressure and in possible wire indentations.

As shown in FIG. 32B, with the rectangular cross-section shape (long side of rectangle parallel to horizontal plane) the force is applied over a larger surface (the mesio-buccal width of the rectangle) resulting in less pressure. The many small vertical arrows indicate that the same upwardly directed force (as is represented by the large arrow in FIG. 32A) is distributed over a larger surface, making pressure on the wire much lower hence eliminating the risk of wire indentations.

A third advantage relates to ease of insertion into a bracket slot. The Conventional combination archwire uses a 021×025 anterior segment, and a 0.021 round in the posterior segment. 021 as vertical dimension has only 001 clearance in the vertical plane. By contrast, an 018×022 posterior portion used in the present invention has 004 of clearance in vertical plane. The larger clearance (004) in the vertical plane of the 018×022 wire makes it easier to insert the archwire than the 021 (clearance001) round wire, when 2^{nd} order bends are present.

A fourth advantage relates to friction reduction. Twisting the wire in the torque (3^{rd}) plane produces less friction than tip (2^{nd} order of space) for rectangular wires (Moore, Harrington, Rock: Factors affecting friction in the pre-adjusted appliance. EJO 2004, 26, 6, 579-583). In other words twisting of the wire due to torque affects binding less than deflections of wire due to tip. So it is not a great advantage to use round wires (that do not have wire-bracket interaction in 3^{rd} order plane of space).

These and other features of the present invention will become apparent to those skilled in the art upon a review of the Drawings and Detailed Description presented below, that describe the best mode of practicing the invention perceived presently by the Applicant.

### BRIEF DESCRIPTION OF DRAWINGS

FIG. 1 is a top plan view of a differential archwire 10 of the present invention showing the anterior segment 11 of the differential archwire 10, and the first and second posterior segments 12, 13 of the differential archwire 10;

FIG. 2 is a lateral view of the differential archwire 10, showing the anterior segment 11, the second posterior segment 13, and the second transition area 15 between anterior 11 and second posterior 13 segment;

FIG. 3 is a front plan view of the differential archwire 10 showing the anterior segment 11, the first 12 and second 13 posterior segments, and the first 14 and second 15 transition points between anterior 11 and posterior 12, 13 segments respectively;

FIG. 4 is a perspective view of the differential archwire 10, showing the anterior segment 11 posterior segments 12, 13 and transition points 14, 15 between anterior and posterior segments;

FIG. 5 is a lateral view of the incisor and of the molar, showing the loss of torque control of the incisor; 51, the center point of resistance of the incisor 51; incisor 21; molar 26; and occlusal plane 28;

FIG. 6 is a lateral view of the appliance 10 in place, showing the anterior segment 11, second posterior segment 13, showing the transition point between anterior and posterior segment 15, central incisor 21, lateral incisor 22, canine 23, first premolar 24, second premolar 25 and molar 26;

FIG. 7 is a lateral view of the cross-section of the anterior segment 11 of the wire 10 that completely fills the slot of the brackets of the incisors, showing anterior segment 11 of the differential archwire 10, view of the section of incisor 21, and incisor bracket 41;

FIG. 8 is a lateral view of the posterior segment with small cross-section area, that occupies the slot of the brackets of canine, premolars and molars; the anterior segment 11 of the differential archwire 10; the posterior segment 13 of the differential archwire 10; the transition point 15 between anterior and posterior segment along with several teeth including canine 23, first premolar 24, second premolar 25 and molar 26;

FIG. 9 is a lateral view of a backwards translation of the incisor 21 showing incisor 21, canine tooth 23, first premolar 24, second premolar 25, and molar 26;

FIG. 10 is a frontal view of the differential archwire 10, wherein a step is created between the anterior segment 11 and the posterior segments 12, 13 of the archwire 10, showing also transition points 14, 15 between anterior 11 and posterior 12, 13 segments, along with first 16 and second 17 bends placed on the archwire 10;

FIG. 11 is a lateral view of the appliance 10 in place, wherein a step is created between anterior 11 and second posterior 13 segments, also showing the transition point 15 between anterior 11 and second posterior segment 13, along with second bend 17 placed on the archwire 10, and their relation to various teeth including, central incisor 21; lateral incisor 22, canine 23, first premolar 24, second premolar 25, molar 26 and the bracket of the canine 29;

FIG. 12 is a lateral view of the incisor illustrating the moment of insertion created by the step placed between anterior 11 and posterior 12, 13 segments of the archwire 10 and showing the center of resistance 51 of the incisor 21 and arm 31;

FIG. 13 is a lateral view of the appliance 10 in place illustrating that in clinical cases with extraction of the first premolars, the anterior segment 11 having a large cross-section area extends from canine to canine showing anterior segment 11, second posterior segment 13, second transition point 15 between anterior and posterior segments and their spatial relation to central incisor 21, lateral incisor 22, canine 23, second premolar 25 and molar 26;

FIG. 14 is a lateral view of the differential archwire 10, wherein the transition between anterior 11 and second posterior 13 segments is gradual, showing anterior segment 11 posterior segment 13, second transition point 15, between anterior 1 and second posterior segments 13

FIG. 15 is a lateral view of the differential archwire 10, with concentric anterior 11 and second posterior 13 segments, also showing the transition point 15 between anterior 11 and second posterior 13 segments;

FIG. 16 is a schematic view of the inside of the mouth of a patient, showing the teeth of a patient;

FIG. 17 is a perspective view of a first alternate embodiment of the present invention;

FIG. 18 is a side view of the gum and teeth of a patient, prior to the installation of the archwire of the present invention, showing brackets attached to the buccal surface of teeth;

FIG. 19 is a side view of a patient's mouth, similar to FIG. 18, except showing the archwire of the present invention installed on the teeth of a user;

FIG. 20 is a side view of a mouth of a patient, similar to FIG. 19, except showing additionally the installation of an elastic chain onto the teeth and brace structure of a patient;

FIG. 21 is a side schematic view of the present invention (in section) installed on a patient's incisor;

FIG. 22 is a side view of the device of the present invention (in section), shown on an incisor, with the relative movement of the incisor shown in phantom;

FIG. 23 is a side, schematic view of an incisor;

FIG. 24 is a side view of the alternate device of the present invention, showing the device bent at a 5 degree angle to generate active torque;

FIG. 25 is a perspective view of the archwire of the invention, placed along side a ruler (11 mm) to help show the scale of the bend illustrated schematically in FIG. 24;

FIG. 26 is a side-schematic view of the archwire of the present invention installed on teeth, in the right upper quadrant of the mouth;

FIG. 26A is a sectional view showing the placement of the archwire of the present invention within a slot of a bracket contained on an incisor;

FIG. 27 is a side schematic view of the archwire of the present invention similar to FIG. 4, except wherein the archwire contains a second order, 15 degree bend;

FIG. 28 is a side schematic view of the archwire of the present invention installed on the upper right hand quadrant of the teeth of a patient, prior to any significant retraction of the incisors by the brace system; and

FIG. 29 is a schematic view, similar to FIG. 28, except showing the differential archwire of the present invention as attached to the upper right hand quadrant of the teeth of a patient, at a point after significant retraction of the incisors has occurred.

FIG. 30 is a schematic view illustrating the forces acting on an incisor that are imparted by the torsional rigidity of the archwire;

FIG. 31 is a schematic view of an archwire extending through brackets of misaligned canines premolars, and molar that is giving rise to deflection of the archwire;

FIG. 32A is a schematic view of a round cross-section area archwire in a slot of a bracket showing a force exerted on the round cross section archwire; and

FIG. 32B is a schematic view of a rectangular cross-section area archwire in a slot of a bracket showing a force exerted on the rectangular cross section archwire

### DETAILED DESCRIPTION

Prior to commencing the description of the present invention, it is helpful to review briefly the anatomy and physiology of the teeth and mouth, as such an understanding is helpful in order to understand the present invention and its operation.

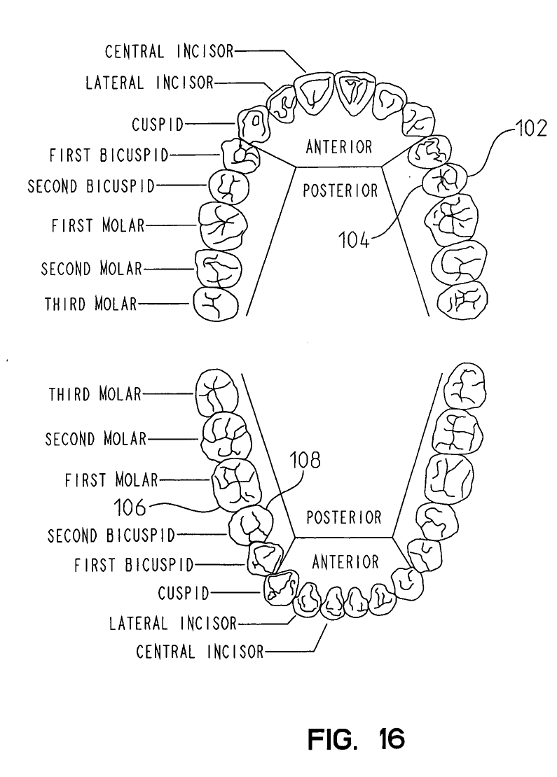

The reader's attention is first directed to FIG. 16, which is a diagrammatic view of the teeth within the upper and lower distal arches. Starting from the front (or the anterior) portion of the mouth, and moving in a posterior direction, the teeth of the mouth include a pair of central incisors, and a pair of lateral incisors. The cuspid is distal to the lateral incisor, and is mesial to the first bi-cuspid, which is often referred to as the first pre-molar. The second bi-cuspid is distal to the first bi-cuspid, and is mesial to the first molar. Continuing posteriorly, the next two teeth include the second molar and third molar.

Additionally, it is important to understand directional conventions. “Anterior” usually refers to the front of the mouth, whereas “posterior” usually refers to the back of the mouth. The anterior teeth include the cuspids and incisors; whereas the posterior teeth include the bi-cuspids and molars.

A tooth typically has a pair of surfaces including a buccal surface 102, which is the surface that is generally next to the cheek, and a lingual surface 104 which is the tooth surface next to the tongue. The term “distal” relates to a direction generally towards the back of the mouth, in a direction generally toward the third molar. For example, one might state that the first molar is distal to the second bi-cuspid.

“Mesial” is a term that relates to forward and front, and is opposed to distal. For example, one might say that the second bi-cuspid is mesial to the first molar. Additionally, the mesial surface 106 of the first molar is adjacent to and may engage the distal surface 108 of the second bi-cuspid. Also, in orthodontics, the mesio-distal inclination of the long axis of the tooth is commonly referred to as “tip”; the bucco-lingual inclination of the long axis of the tooth is commonly referred to as “torque”.

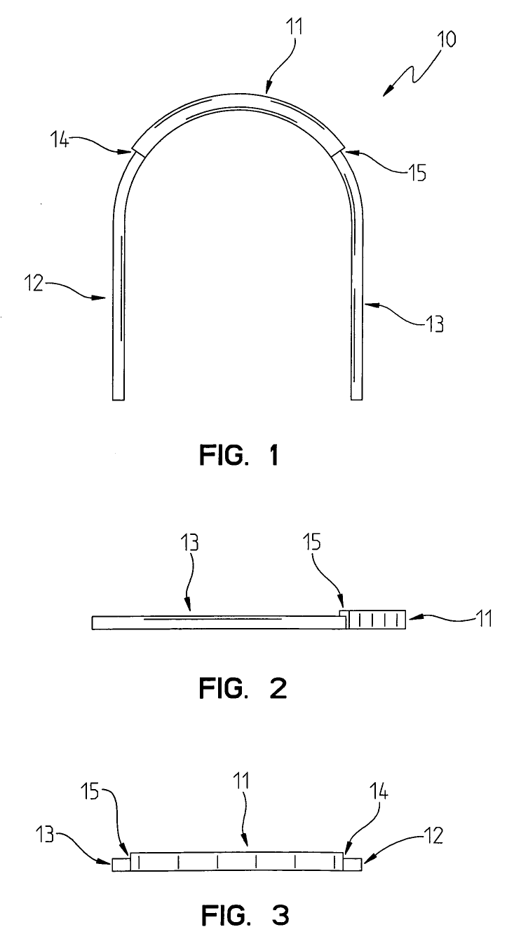

As best shown in FIG. 1, the differential archwire 10 of a first embodiment of the present invention is shown as including an anterior portion 11, a first posterior portion 12, and a second posterior portion 13. When inserted in the mouth, the anterior portion 11 is disposed adjacent to the anterior teeth, such as the central and lateral incisors. The first 12 and second 13 posterior portions are disposed adjacent to the posterior teeth, such as the canines, the first and second bi-cuspids (first and second pre-molars), and the first, second and third molars.

If one views the dental archwire 10 from the top, as shown in the top view of FIG. 1, the first posterior portion 12 will be inserted into the left portion of the mouth, and that the second posterior portion 13 of the dental archwire 10 will be disposed in the right portion of the mouth.

As will be observed from the drawings in FIGS. 1-4, the anterior portion 11 is generally thicker than the posterior portions 12, 13. Another way to state this is that the cross sectional area of the anterior portion 11 is generally greater than the cross sectional area of the first and second posterior portions 12, 13. A first transition area 14 comprises the area where the anterior portion 11 meets the first posterior portion 12. A second transition portion 15 is the portion of the dental archwire 10 where the anterior portion 11 intersects with the posterior portion 13. The first posterior portion 12 terminates in a distal end 12a, and the second posterior portion terminates at a second distal end 13a.

Both of the anterior 11 and posterior 12, 13 portions of the archwire 10 preferably comprise wires having a generally square or rectangular cross section. As will be described in more detail below, the use of such a rectangular or square cross section has several advantages over a round cross section wire, as a square or rectangular cross sectional wire has a greater ability to apply desired pressure upon the teeth, to cause the teeth to move in a direction desired by the user and his orthodontist.

The anterior portion 11 has a generally larger cross section than the posterior portions 12, 13. The relatively larger cross sectional area and higher rigidity of the anterior portion 11 helps to control the mesio-distal inclination (tip) and bucco-lingual inclination (torque) of the incisors during their retraction.

By contrast, the relatively thinner cross section and lower rigidity of the posterior portions 12, 13 enables the posterior portion 12, 13 of the wire to slide with minimal friction within the slots of the brackets that are placed on the canine 23, premolars 24,25, and molar 26 teeth.

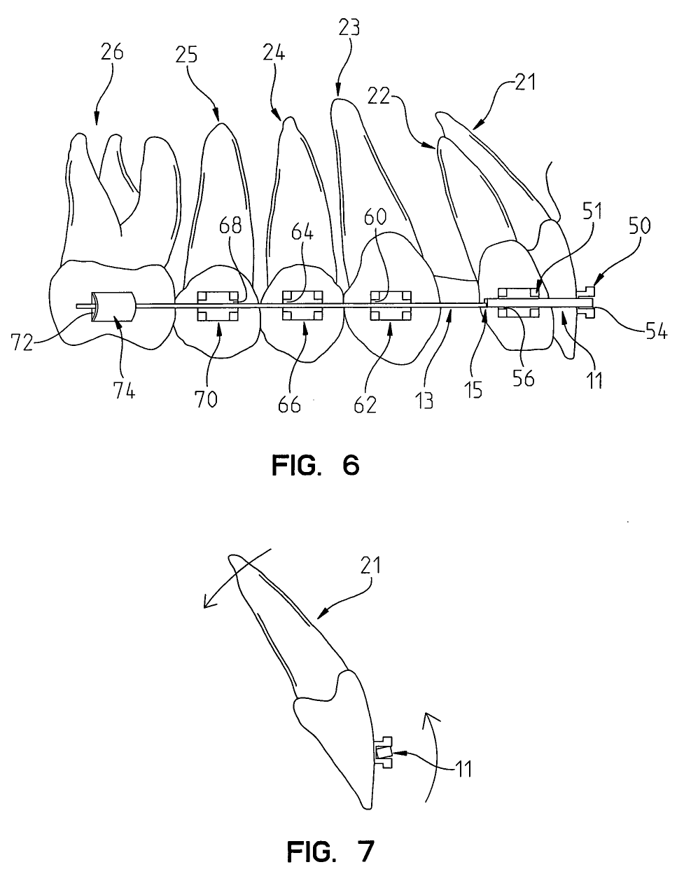

The “differential archwire” 10 is used to retract the incisors 21, 22 (FIG. 6). After the retraction of the incisors 21, 22 is completed, the archwire 10 can be easily replaced with little cost and with little chair-time by an archwire with a generally uniform, large cross-sectional area along the entire length of the archwire, in order to have full control of the torque of the posterior teeth. The material that constitutes the archwire 10 is preferably, but not necessarily, stainless steel.

As shown in FIG. 6, the anterior segment 11 of the archwire 10 is inserted into the slot 54 of the bracket 50 of the central incisor 21, and into slot 56 of the bracket 51 of the lateral incisor 22. The posterior segments 12, 13 are inserted into the slots of the brackets of the canine 23′ bicuspids 24, 25 and molar 26. The anterior portion of the posterior segment 13 is inserted into the slot 60 of the bracket 62 that is fixedly attached to the canine 23, as shown in FIG. 6. Additionally, the posterior segment 13 of the differential archwire 10 is shown as being inserted in the slots 64, 68 of the brackets 66, 70 that are fixedly attached to the buccal surfaces of the first 24 and second 25 premolars. The posterior end portion of the posterior segment 13 of the differential archwire 10 extends through the slot 72 of the buccal tube 74 that is fixedly attached to the buccal surface of molar 26.

The anterior segment 11 of the archwire has a relatively larger, square or rectangular cross-sectional area, in order to substantially fill the slots 54, 56 of the central 21 and lateral 22 incisors, and to generate a good control of the mesio-distal inclination (tip) and bucco-lingual inclination (torque) of the incisors 21, 22 during their retraction. More in detail, the interaction between the archwire 10 with rectangular cross-section and the slots 54, 56, also with rectangular cross-section, generates forces along at least two sectors that push the roots of the incisors towards the palate (FIG. 7). The final result that is obtained is the desired backward translational movement of the incisors in a direction indicated by the Arrows C of FIG. 9.

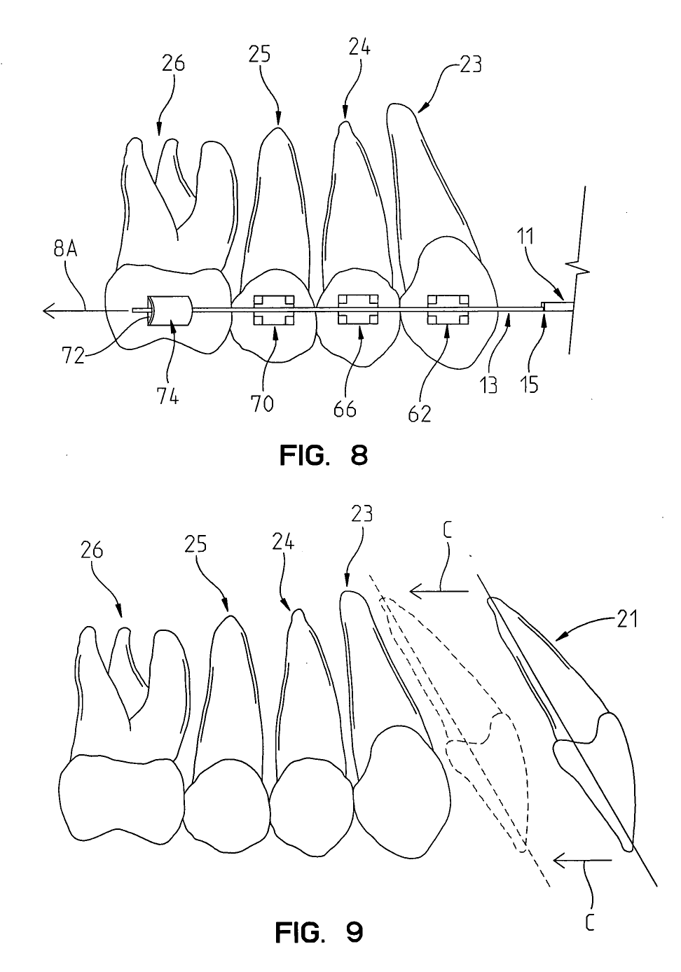

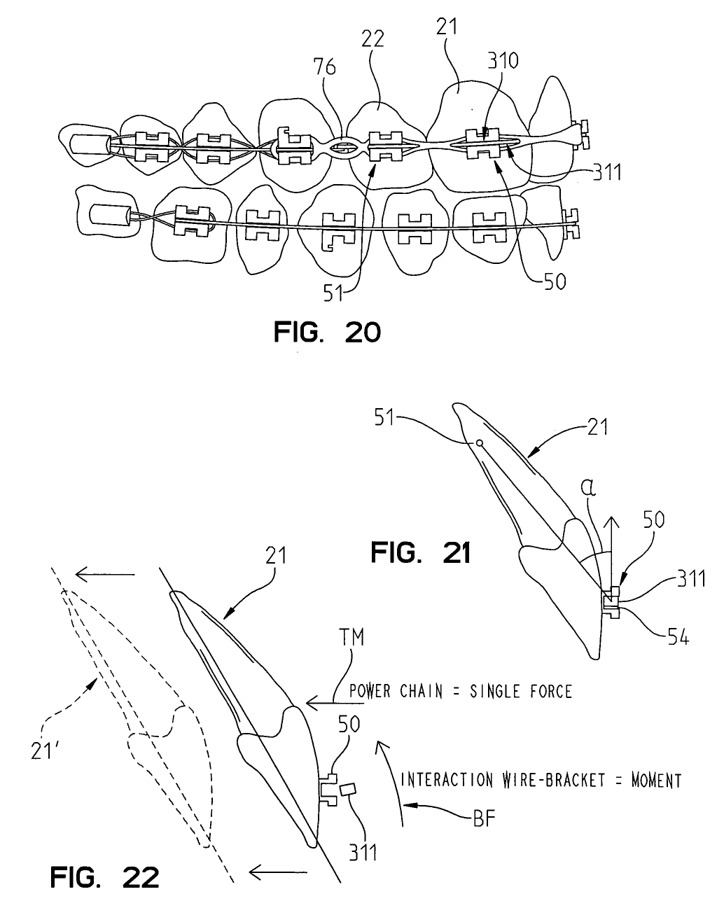

The posterior segments 12, 13 have a smaller cross-section area than the anterior segment 11, in order to allow the posterior segments 12, 13 to slide with minimal friction along slots 60, 64, 68, 72 of the brackets 62, 66, 70, 74 of the canines, premolars, and molar. A force, generated by elastic chains 76 (FIG. 20) or coil springs, is applied from the incisors 21, 22 to the posterior teeth 23, 24, 25, 26. As incisors 21, 22 retract, the posterior segments 12, 13 of the archwire 10 having a smaller cross-section area, slide along the slots 60, 64, 68, 72 of the brackets 62, 66, 70, 74 of canines, premolars and molars in a posterior direction as indicated by Arrow 8A of in FIG. 8.

Furthermore, it is known that the rigidity of an archwire 10 is directly proportional to the cross-sectioned area of the wire from which the archwire 10 is made. As a consequence, the anterior segment 11 that is thicker is also more rigid and less likely to deflect or twist or permanently deform. This rigidity helps to control the mesio-distal inclination (tip) and bucco-lingual inclination (torque) of the incisors 21, 22 during their retraction.

The posterior segments 12, 13 have a smaller cross-section area in order to provide enough room so that space exists between the wire 12 and 13 and the walls of the slots of tle posterior teeth canine 23, premolars 24, 25, molar 26. This space allows the wire to slide along the slots with minimal friction along the brackets of the canines, premolars and molars when the incisors are retracted (FIG. 8). Also, the posterior segments 12, 13 with a smaller cross-section area, are more flexible. It is known that the friction generated by two surfaces that have to slide on one another is directly proportional to the force applied to the surfaces. Thinner wires are more flexible, hence, when they are deflected, they give a lower force response than the force response given by thicker wires. The force response of deflected wires acts at the wire-bracket interface producing friction that hampers the backward sliding of the wire through the brackets of the posterior teeth canine 23, premolars 24, 25, molar 26 (FIG. 8). The smaller cross-section area and reduced rigidity of the posterior segments 12, 13 helps them to slide with low friction along the brackets of the posterior teeth 23, 24, 25, 26 also when these teeth 23, 24, 25, 26 are not perfectly aligned and deflect the posterior segments 12, 13 of the archwire 10. Several studies show that when archwires are deflected by misaligned teeth, wires with smaller cross-section dimensions, hence more flexible, slide through brackets with lower friction than thicker wires. See:—Thorstenson G A, Kusy RP: “Effect of Archwire Size and Material on the Resistance to Sliding of Self-Ligating Brackets With Second-Order Anglation in the Dry State”: American Journal of Orthodontics and Dento facial Orthopedics 2002 September; 122 (3): 295-305. —See also, Moore M M, Harrington E, Rock: “Factors Affecting Friction in the Pre-Adjusted Appliance”: European Journal of Orthodontics 2004 26 (6): 579-583.

Further, the importance of lower flexural rigidity for reducing wire-bracket binding phenomena is supported by studies that show that for the same cross-sectional size. Nickel-Titanium wires bind less to brackets than Stainless Steel wires. Stainless Steel wires, even if they have a lower coefficient of friction than Nickel-Titanium wires due to the better surface features, experience more binding than Nickel-Titanium wires when they are deflected by the brackets. The reason is that Nickel-Titanium alloy has a lower modulus of Young with respect to Stainless Steel. For the same cross-sectional wire size, Nickel-Titanium wires have lower flexural rigidity than Stainless Steel wires, hence when deflected generate a lower force response. Lower force response generates lower friction at the bracket-wire interface and reduce binding. See, Articolo L C, Kusy R P: “Influence of Angulation on the Resistance of Sliding in Fixed Appliances: American Journal of Orthodontics and Dentofacial Orthopedics 1999 January, 115 (1): 39-51.

In fact, wires with higher rigidity generate higher torsional moments when they interact with the rectangular bracket slot (FIG. 7), thus moving the incisor roots backwards more effectively and obtaining a bodily movement (translation) of incisors (FIG. 9). It is known that a “moment of a couple” is generated by two parallel forces of equal magnitude acting in opposite directions and separated by a distance. In the case of the wire-bracket interaction on the incisors, forces are F1 and F2 separated by the distance d (where d is the width of the anterior portion 311 of alternate embodiment wire 310), such as that shown in the FIG. 30.

The cross-section of the anterior portion 311 of the wire 310 interacts with the slot 54 walls 355 of incisor bracket 50 and generates a “moment of a couple”. The moment of a couple is F1×F2×d, where d is the width of the cross-section of the anterior portion 311 of alternate embodiment archwire 310 (FIG. 30).

For a long time orthodontists have had problems appropriately torquing the incisor roots towards the palate. Difficulties arose because the torsion of the orthodontic wire (needed to generate the moment) is applied in an area where the cross sectional area of the wire is relatively small, when compared to the large dimensions of a tooth (FIG. 7). Wires with higher rigidity generate higher forces (F1 and F2 in FIG. 30) hence higher moments, and are much more effective in torquing the roots of incisors towards the palate (FIGS. 7, 22, 30).

Both flexural and torsional rigidity are strictly related to cross-section dimensions (area) of the wire. For the rectangular cross-section shape,

Torsional Rigidity=G×J, where:
G is Torsional Modulus of Elasticity

J=H×b³/q
H and b are the two dimensions of the rectangle

q is the torsion factor=2.60/(0.45+H/b)+3

Wires with larger cross-section dimensions (area) have higher torsional rigidity. For example, we will calculate on a percentage basis, how much higher is the torsional rigidity of the anterior segment 311 (size 21×25 thousands of inch) when compared with the torsional rigidity of the posterior segments 312, 313 (size 18×22 thousands of inch), if the same material is used (hence G torsional modulus of elasticity is the same) in the anterior 311 and posterior 312, 313 segments.

J for the anterior segment 311 (size 21×25 thousands of inch) is:

q=2.60/(0.45+25/21)+3=4.58

J=25×21³/4.58=50.551

J for the posterior segments 312, 313 (size 18×22 thousands of inch) is:

q=2.60/(0.45+22/18)+3=4.55

J=92×18³/4.55=28.198

Since torsional rigidity=G×J,

Torsional rigidity of anterior segment 311 (size 21×25 thousands of inch)=G×50.551, Torsional rigidity of posterior segments 312, 313 (size 18×22 thousands of inch)=G×28.198. Since G is the same in the anterior 311 and posterior 312, 313 segments of our example, because we are using the same material in all segments of the archwire, we can erase G in the above formulas and find the ratio:

50.551/28.198=1.79

which means that the torsional rigidity of the anterior segment (size 21×25) is 1.79 times larger than the torsional rigidity of the posterior segments (size 18×22).

Flexural rigidity is used in a conventional sense, as defined by Young's module times the second moment of inertia of the wire cross-section. The second moment of inertia is used in structural engineering to predict the resistance to deflection of a body. The second moment of inertia for rectangular cross section shape is:

I=b×h³/12 where,
b is width, and
h is height of the rectangle

A typical “differential archwire 10, 310” has an anterior segment of size 0.021″×0.025″ and posterior segments of size 0.018″×0.022″. Unless otherwise specified, archwire dimensions are expressed, e.g. 18×21 equals 0.018″×0.021″ and exposed herein in thousandths of an inch. We will calculate second moment of inertia for anterior and posterior segments, and will show that in this embodiment of archwire the flexural rigidity of the posterior segments is 45% lower (less) than the flexural rigidity of the anterior segment 311.

The second moment of inertia for the anterior segment 311 (whose dimensions are 21×25) is determined by:

I=b×h³/12, which=25×21³/12, which=19,293.75

The second moment of inertia for posterior segments 312, 313 (which have dimensions 18×22) is determined as follows:

I=b×h³/12, which=22×18³/12, which=10,692

At this point, we can calculate on a percentage basis, how much lower the second moment of inertia (I) is on the posterior segments 312, 313 when compared with the second moment of inertia of the anterior segment 311 as follows:

19,294−10,692=8.602

8,602/19,294=0.4458=0.45=45%

If the same material (stainless steel for example) is used in each of the anterior 311 and posterior 312, 313 segments, the Modulus of Young is the same in anterior 311 and posterior 312, 313 segments. In the embodiment of the differential archwire shown in FIG. 17, the posterior segments 312, 313 (18×22) have a flexural rigidity (flexural rigidity=Young's module times the second moment of inertia) that is 45% less than the flexural rigidity of the anterior segment 311 (21×25).

As such, reducing the cross-section dimensions of the wire is a powerful means for reducing the flexural rigidity of the wire to thereby enable the user to choose a wire size which yields the flexural rigidity properties that the user desires. Practically this is very useful, because reduced flexural rigidity greatly improves sliding mechanics. There is much research going on currently on sliding mechanics. Sliding mechanics relates to moving teeth by sliding the archwire through the brackets of the teeth, or vice versa, by sliding brackets along archwires. In the archwire design of the present invention, the Applicant employs sliding mechanics to retract incisors. As the incisors retract, the posterior segments 312, 313 of the wire 310 slide backwards through the brackets 62, 66, 70, 74, of posterior teeth canine 23, bicuspids 24, 25 and molar 26 (FIG. 8).

Clinically it frequently happens that canines 23, premolars 24, 25, and molars 26 are not perfectly aligned, and they deflect the posterior segments of the differential archwire, as is shown in FIG. 31.

As best shown in FIG. 31, when the brackets 62, 66, 70, 74 of canine 23, premolars 24, 25, molar 26, are not perfectly aligned, the posterior segments 312, 313 of the differential archwire 310 are deflected and this generates wire-bracket binding that hampers the sliding of the wire 312, 313 and also hampers incisor retraction. With sliding mechanics, wire-bracket binding has been an issue for many years. In fact, if teeth are not perfectly aligned, the brackets that are attached to the teeth deflect the wire 312, 313. As the wire 312, 313 is deflected, the wire reacts by exerting a force response due to the elastic memory of the wire. The force response of the wire 312, 313 acts at the wire 312 bracket 60, 64, 68, 72 interface, producing friction that hampers the sliding of the wire 312, 313 through the brackets 62, 66, 70, 74.

For a cantilever beam (beam attached at one extremity only) of orthodontic wire, the force response of the wire, when deflected, is:

Force response=3×E×I×f/L³
Where
E=modulus of Young
I=second moment of inertia of the wire cross-section
f=linear deflection of the wire
L=length of the beam (span) of wire

The Applicant has found that there is a directly proportional (linear) relationship between flexural rigidity (E×I) and force response of a deflected wire.

In the embodiment 300 of differential archwire 300 shown in FIG. 16-31, for the same amount of linear deflection of the wire (f in the above formula) and for the same length of wire (L in the above formula), the posterior segments (18×22) generate a force response that is 45% less than the force response generated by the anterior segment 311 (21×25) due to the differences in cross-section sizes of the segments 312, 313, 311.

The force response of a deflected orthodontic wire acts at the wire-bracket interface. More precisely, during incisor retraction, this force response of the deflected wire is exerted in a perpendicular fashion (normally) to the direction of backward sliding of the wire through the brackets. The direction of the force response of the deflected wire is indicated generally by arrows 74A, 70A, 66A and 62A shown in FIG. 31. So, the force response of the deflected wire produces friction, that hampers the backward movement of the wire (and of incisors).

In fact, from the definition of friction:

FRICTION=μ×Fn
where,
μ=coefficient of friction
Fn=normal force exerted between the surfaces

We can recognize that the coefficient of friction depends on the surface features of the two engaging objects, which is typically related to the type of material used for the two objects.

In the embodiment 300 of differential archwire 300 shown in FIG. 16-31, the coefficient of friction (p) is the same for both the anterior 311 and posterior 312, 313 segments, because the material from which each is made is the same. The normal force exerted between bracket and wire (Fn in the above formula) is represented by the force response of the deflected wire.

When deflected, posterior segments 312, 313 (having dimension of 18×22) generate a force response that is 45% less than the force response generated by the anterior segment 31 (having a dimension of 21×25), as shown in the previous paragraph. As a consequence, for the same amount of wire deflection, the posterior segments 312, 313 (18×22) generate 45% less friction than the anterior segment 311 (21×25).

Reduced friction greatly improves the ability of the posterior segments 312, 313 (18×22 size) to slide through the slots 60, 64, 68, 72 of the brackets of canines 23, premolars 24, and molars 26 during incisor 21, 22 retraction (FIG. 31). This enables the incisor 21, 22 retraction to be accomplished more quickly and more efficiently. In fact, several studies show that when archwires are deflected by misaligned teeth, wires with smaller cross-section dimensions, hence more flexible, slide through brackets with lower friction than thicker wires. See—Thorstenson G A, Kusy R P: “Effect of Archwire Size and Material on the Resistance to Sliding of Self-Ligating Brackets With Second-Order Anglation in the Dry State”: American Journal of Orthodontics and Deniofacial Orthopedics 2002 September; 122 (3): 295-305. See also, —Moore M M, Harrington E, Rock: “Factors Affecting Friction in the Pre-Adjusted Appliance”: European Journal of Orthodonlics 2004 26 (6): 579-583.

Further, the importance of lower flexural rigidity for reducing wire-bracket binding phenomena is supported by studies that show that for the same cross-sectional size, Nickel-Titanium wires bind less to brackets than Stainless Steel wires. Stainless Steel wires, even if they have a lower coefficient of friction than Nickel-Titanium wires due to the better surface features, experience more binding than Nickel-Titanium wires whey they are deflected by the brackets. The reason is that Nickel-Titanium alloy has a lower modulus of Young with respect to Stainless Steel. For the same cross-sectional wire size, Nickel-Titanium wires have lower flexural rigidity than Stainless Steel wires, hence when deflected generate a lower force response. Lower force response generates lower friction at the bracket-wire interface and reduces binding. See, Articolo LC, Kusy RP: “Influence of Angulation on the Resistance to Sliding in Fixed Appliances.” American Journal of Orthodontics and Dentofacial Orthopedics 1999 January; 115 (1). 39-51.

For example, if we work with brackets 50, 51, 62, 66, 70, 74 that have slots 54, 56, 60, 64, 68, 72 having identical dimensions of 0.022 inches by 0.028 inches (0.55880 by 0.711.20 mm) on all teeth, the size of the “differential archwire 310” should preferably but not necessarily, be such that its cross sectional dimensions are either 0.021 by 0.025 inches (0.53340 by 0.63500 mm), or 0.020 by 0.025 inches (0.50800 by 0.63500 mm) in the anterior segment 311. The posterior segments 312, 313 will preferably, but not necessarily have cross sectional dimensions of in the range of 0.018 by 0.022 inches (0.45720 by 0.55880 mm), and 0.017 by 0.022 inches (0.43180 by 0.55880 mm). If we employ brackets 50, 51, 62, 66, 70, 74 with slots 54, 56, 66, 64, 68, 74 having dimensions of 0.018 by 0.022 inches (0.45720 by 0.55880 mm) on all teeth, the differential archwire 10, 310 will preferably, but not exclusively, have a cross sectional dimension of 0.018 by 0.022 inches (0.45720 by 0.55880 mm), or 0.017 by 0.025 inches (0.43180 by 0.63500 mm) in the anterior segment 311; and 0.016 by 0.020 inches (0.40640 by 0.50800 mm) or 0.016 by 0.018 inches (0.40640 by 0.45720 mm) in the posterior segments 312, 313.

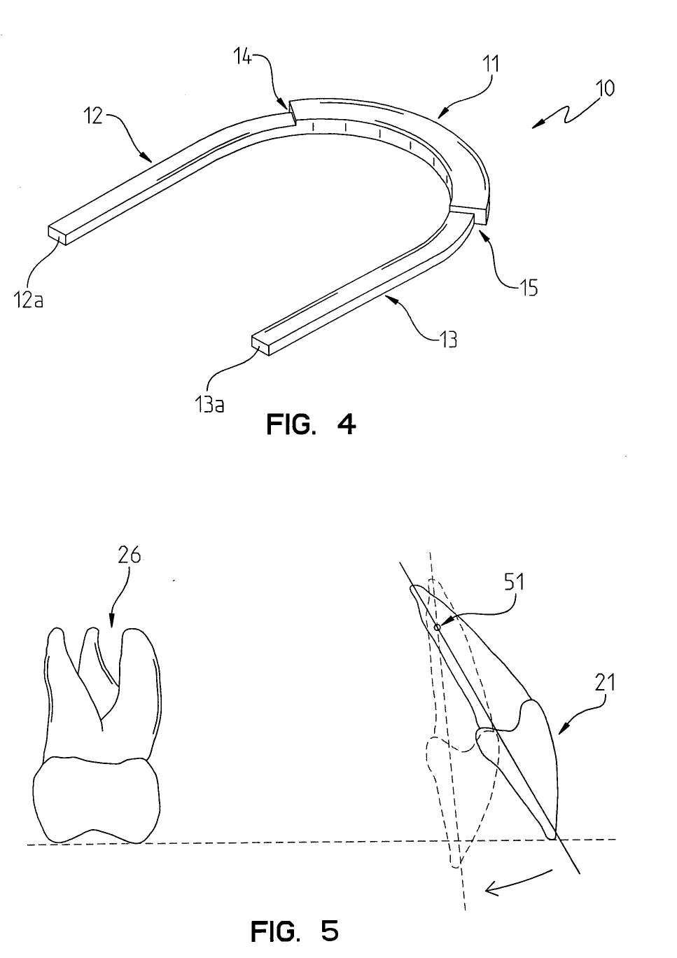

The shape of the cross-section of the anterior segment 11 or of the posterior segments 12, 13, or of all three segments can be a polygon (square, rectangle, octagon, hexagon), or trapezium. Preferably the segments 11, 12, 13 have a rectangular shape with the long side of the rectangle placed along the horizontal plane (FIG. 4). The forces that are utilized to close the spaces between the teeth that are in the dental arch are exerted over a semi-circle. Hence, these forces have a centripetal component, and they tend to push the teeth inwardly towards the side of the tongue and to thereby generate a decrease of the transverse diameter of the dental arches. The component that resists these centripetal forces is the rigidity of the archwire along the horizontal plane with a more rigid archwire doing a better job of resisting these forces than a less rigid archwire. For this reason it is preferable to use an archwire with rectangular cross-section with the long side of the rectangle placed along the horizontal plane.

This shape of the cross-section of the archwire 310 ensures a higher rigidity of the archwire along the horizontal plane when compared to round cross-sectioned wires that are sized to be received in similar sized brackets. The higher rigidity of the rectangular archwire helps to maintain a correct transverse dimension of the dental arch during incisor retraction.

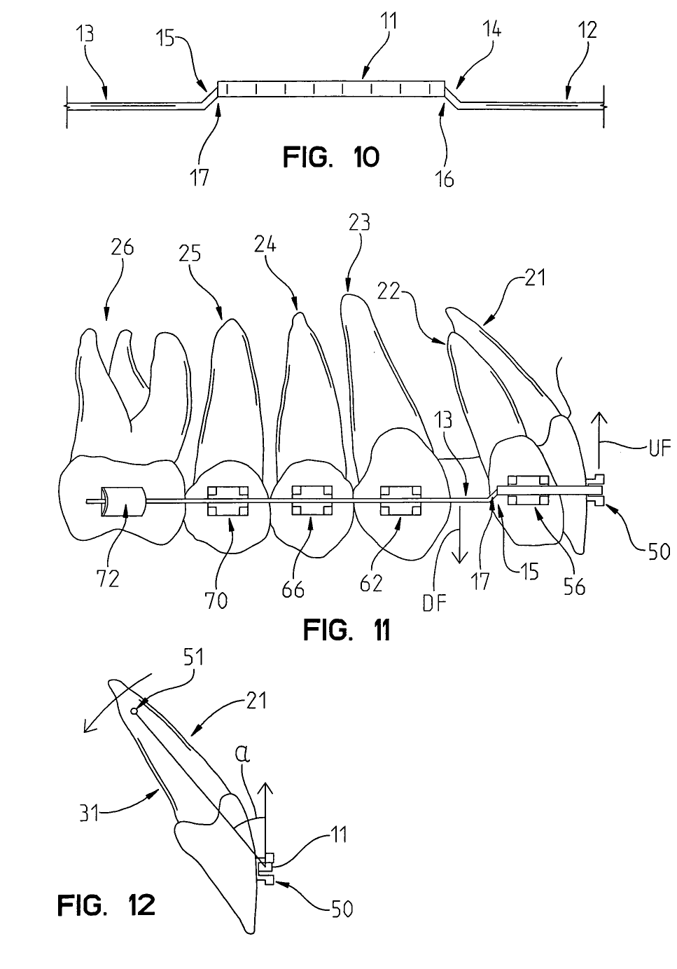

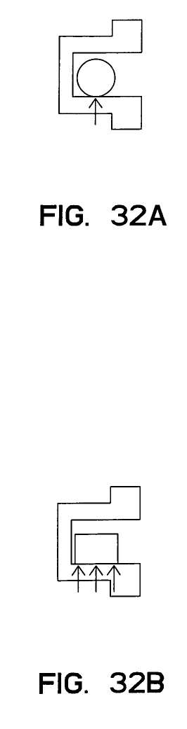

Additionally, a rectangular cross-section shape is preferred over the round cross-shape, because when the anterior segment 311 is placed in a non-colinear, parallel plane relationship, such as is shown in FIG. 17 and FIGS. 10, 11, the wire deflects and a force is generated at the wire-bracket interface of the canine 23, creating wire-bracket binding phenomena. In this situation, the edge of the canine bracket 62 (FIG. 11) generates a high pressure that can permanently deform (notch or bite into) a round wire (FIG. 32A), making indentations on the wire surface and hampering sliding mechanics. With the rectangular wires of the present invention the force is exerted over a larger surface, comprising the entire bucco-lingual width of the rectangle (FIG. 32B), resulting in less pressure. As a result, this “biting” effect doesn't occur. This phenomena concurs with the findings of Frank and Nikolai that an 0.020 round wire results in more friction than the 0.017×0.025 inch rectangular wire when wire-bracket angulations exist. See Frank C A, Nikolai R J: “A Comparative Study of Frictional Resistances between Orthodontic Bracket and Archwire;” American Journal of Orthodontics 78 (6):593-609, 1980 December).

The first embodiment archwire 10 and the second embodiment archwire 310 induce this “step” in different ways. Turning first to FIG. 10, it will be noted that the archwire 10 includes an anterior portion 11 that is placed in non-coplanar relationship with the posterior portions 12 and 13. This non-coplanar relationship is enabled by a first bend 16 that is placed in a transition area 14 between the anterior segment II and posterior segment 12; and a second bend 17 that is placed in the posterior section 13 at the transition area 15, between the posterior section 16 and the anterior portion 11. As shown in FIG. 12, it will be noted that the anterior segment 11 is placed in a parallel plane to the posterior segments 13 that is generally above the posterior segment 13.

The bends 16, 17 that induce this non-coplanarity can either be preformed at the factory, or else bent by the orthodontist at his office to the degree that he believes desirable and necessary based on the conditions found within the mouth and teeth of the patient just prior to installation.

As best shown in FIG. 17, the posterior segments 312, 313 are placed in a co-planar relationship. However, the posterior sections 312, 313 are placed in a parallel plane with anterior segment 311, wherein the planes are not co-planar.

The plane in which the anterior segment 311 resides is disposed generally above the level of the plane in which the posterior segments 312, 313 reside. Rather than using a bend to differentiate the level between the anterior section 311 and posterior section 312, 313, in the embodiment 310 shown in FIG. 17, the non-coplanarity is achieved by attaching the underside surface of the posterior end portions 323, 325 of the anterior segment 311 to the upper side surfaces of the proximal end portion 322, 324 of the respective posterior segments 312, 313. This overlayed transition section 314, 315, as described above, is an area where the thickness of the archwire, due to the combined cross-sectional areas of the anterior segment 311 and posterior segment 312, 313 is greater than in any other place within the archwire. This results in the transition area 314, 315 having the highest flexural rigidity of any portion of the archwire 310.

An alternate and preferred embodiment archwire 310 is shown in perspective in FIG. 17. Archwire 310 includes a curved anterior portion 311, that is placeable adjacent to the front teeth of the mouth, such as the incisors. In addition to the anterior segment 310, the archwire 311 includes a first posterior segment 312 and a second posterior segment 313. The first posterior segment 312 is coupled to the anterior segment 310 in a transition portion 314, wherein a portion of the proximal portion 322 of the first posterior archwire 312 is overlapped with the first end portion 323 of the archwire 311. Similarly, a second transition portion 315 exists, wherein the second end 325 is overlapped with the proximal portion 324 of the second posterior segment 313. It will also be noted that the anterior segment is generally arcuate. The posterior sections 312, 313 each include generally curved proximal portions 322, 324, respectively, and linear distal portions 328, 330 respectively. The posterior segments 312, 313 terminate at their most posterior points in distal ends 332, 334. Although the distal ends 332, 334 may be bent to retain them in brackets after the archwire 310 is inserted into a mouth, it is preferred that the linearity of the distal portions 328, 330 be maintained when the archwire 310 is manufactured, and generally before the archwire 310 is inserted into the mouth of a patient. When so inserted, the distal ends 332, 334 may (or may not) be chosen by the orthodontist to be bent.

One feature of the archwire 310 is that the posterior segment 312, 313 and the anterior segment 319 generally have a rectangular cross section. In this rectangular cross section, the longer dimension of the rectangle is the upper surface 336 of second posterior portion 313; and the smaller dimensions is possessed by the vertically disposed side surfaces, such as lingual surface 338 of first posterior segment 312.

It will further be noted that the wires of the posterior portions 312, 313, are generally thinner and have a smaller cross sectional area than the anterior segment 311. For example, in an embodiment that is likely to have the most typical sized segments, the anterior segment has a dimension of 0.021″×0.025″ (0.53 mm×0.64 mm); whereas the posterior segment has dimensions of 0.018″×0.022″ (0.46 mm×0.56 mm).

It will further be noted that the posterior segments 312, 313 are disposed in a parallel, but different plane than the anterior segment 311. This non-planarity results from the underside surface of the anterior segment 311 being joined to the upper surface of the posterior segments 312, 313 in a manner where the first and second ends 323, 325 of the anterior segment 311 overlap the proximal ends 322, 324 of the respective posterior sections 312, 313. Through this arrangement, the posterior segments 312, 313 are not co-linear with the anterior segment 311.

Further, while the anterior segment 311 and posterior segments 312, 313 are disposed in parallel planes, they are not disposed to be co-planar. Also, relatively significantly greater intermediate first and second 314, 315 thickened portions are formed at the point wherein the anterior segment 311 is joined to the respective first and second posterior segment 312, 313. This thickened intermediate portion of the embodiment described above, has a dimension of 0.039″ in height, times 0.025″ in width (0.99060 mm×0.63500 mm). Due to the different thicknesses between this intermediate transition portion 314, 315 and the respective anterior segment 311 and posterior segments 312, 313, these transition portions 314, 315 functionally form first and second intermediate segments 314, 315 that have a greater flexural rigidity than either the anterior segment 311 or the posterior segments 312, 313. These transition segments 314, 315 will, from time to time be referred to in this application as the “step” portion, as this portion does function as a step between the posterior segments 312, 313 respectively and the anterior segment 31.

This force caused by the parallel plane placement tends to push the archwire against the edge of the canine bracket 62. With round wires, the bracket 62 of the canine 23 can make indentations into the round wire, making the wire surface rough and hampering sliding mechanics (FIG. 32A). With the rectangular wires of the present invention the force is exerted over a larger surface, comprising the entire bucco-lingual width of the rectangle, resulting in less pressure (FIG. 32B). As a result, this “biting” effect doesn't occur on the rectangular wire. This phenomena concurs with the findings of Frank and Nikolai that a 0.020 round wire results in more friction than the 0.017×0.025 inch rectangular wire when wire-bracket angulations exist. See Frank C A, Nikolai R J: “A Comparative Study of Frictional Resistances between Orthodontic Bracket and Archwire;” American Journal of Orthodontics 78 (6):593-609, 1980 December).

Sometimes the patient presents a big overlap of the upper incisors, which is referred to as a over the lower incisors deep overbite. In these cases, it is necessary to intrude the upper incisors before their retraction, in order to avoid interferences of the upper incisors with the lower incisors during the retraction. In order to accomplish this objective, a step can be created between the anterior segment 11, and the posterior segments 12, 13 of the archwire (FIGS. 10, 11).

This step will be created preferably, but not necessarily, by means of two bends 16, 17 placed one on each side in a position distal to the lateral incisors 22, in the transition point 14, 15 between anterior and posterior segments (FIG. 10). This step 16, 17 will intrude the incisors 21, 22 and will extrude the posterior teeth 23, 24, 25, 26, creating a reduction of the overbite (FIG. 11). The fact that the posterior segments 12, 13 of the archwire are thin and hence more flexible, helps to keep the force applied to the canine bracket 62 and the friction at low levels, and to allow the sliding of the archwire 12, 13 along the brackets of the posterior teeth 23, 24, 25, 26.

Also, this step caused by bends 16, 17 generates a moment given by the intrusive force multiplied by the arm 31 and by the sine of the angle alpha delineated by the arm 31 and the intrusion force, as shown in FIG. 12. This happens because the point of application of the intrusion force is placed in a position that is buccal in relation to the center of resistance 51 of the tooth. This moment generates an increase of the buccal-crown torque of the incisors 21, 22 that is very beneficial during their retraction.

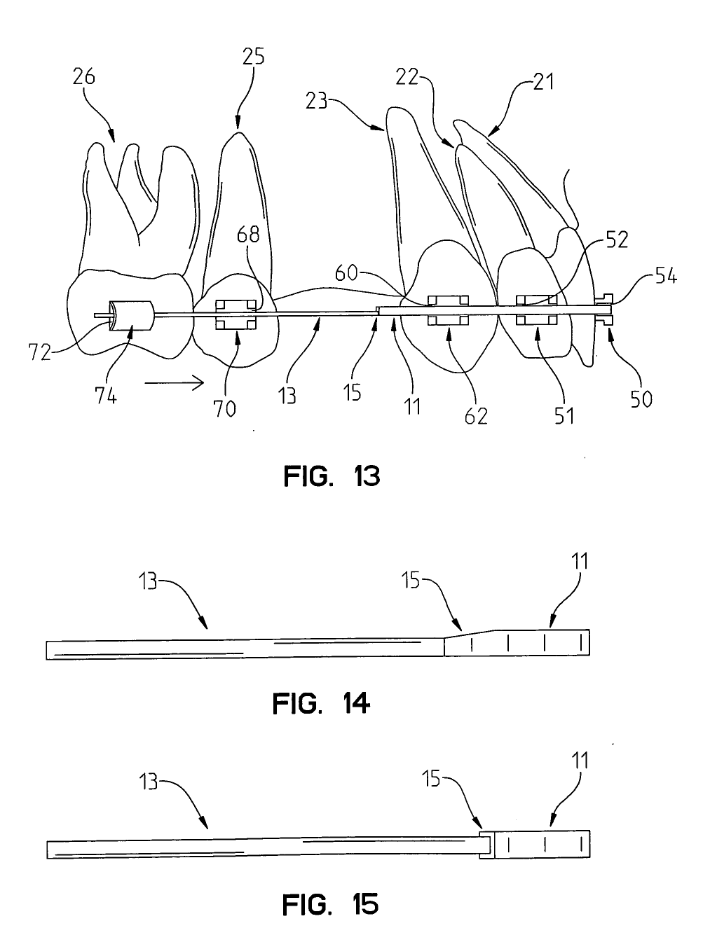

The differential archwire 10, 310 can be utilized also in the clinical cases where the first premolars are extracted (FIG. 13), in order to create space in the dental arches to align crowded teeth. In clinical practice wherein crowded teeth are an issue, the first step is often to extract the first premolars. After the first premolars are extracted, then the canines 23 are moved backwards in order to align the incisors 21, 22. At this point, if residual space remains in the dental arches, many clinicians prefer to keep the position of incisors 21, 22 and canines 23 unchanged, and to close the residual space by means of the advancement of the second premolar 25 and of the molar 26 (FIG. 13).

In this phase of treatment, a differential archwire can be utilized, presenting the anterior segment 11 with a relatively larger cross-section area being placed in the brackets 50, 51, 62 of the incisors 21, 22 and canines 23, and the posterior segments 12, 13 with small cross-section area occupying the brackets of the second premolars 25 and of the molars 26 as shown in FIG. 13. The anterior segment 11 of the archwire with the relatively larger cross-section area gives good control to the inclination of the incisors 21, 22 and of the canines 23, while the second premolars 24, 25 and the molars 26 can slide forward, under the effect of the class I force, and close the residual space of extraction. The posterior segments 12, 13 with the relatively small cross-section area generate low friction in the slots 68, 72 of the premolars 25 and molars 26. Furthermore, the larger anterior segment 11 of the archwire that extends between the left and the right canines resists the centripetal forces and helps to maintain a correct and proper transversal diameter of the dental arches. This control of the transversal diameter of the dental arches is increased by the fact that the shape of the cross-section of the archwire is rectangular with the long side of the rectangle placed along the horizontal plane, both in the anterior segment 11 and in the posterior segments 12, 13 of the archwire (FIG. 4).

Described below is an exemplary technique and method wherein the inventive dental archwire of the present invention can be employed by a dental professional in an orthodontic procedure.

### A. Differential Archwire: a New Orthodontic Technique

The differential archwire 10, 310 of the present invention is utilized to retract the incisors, using a sliding mechanics. For simplicity, references hereinafter will be directed to archwire 310, although it will be appreciated that archwire 10 could also be employed.

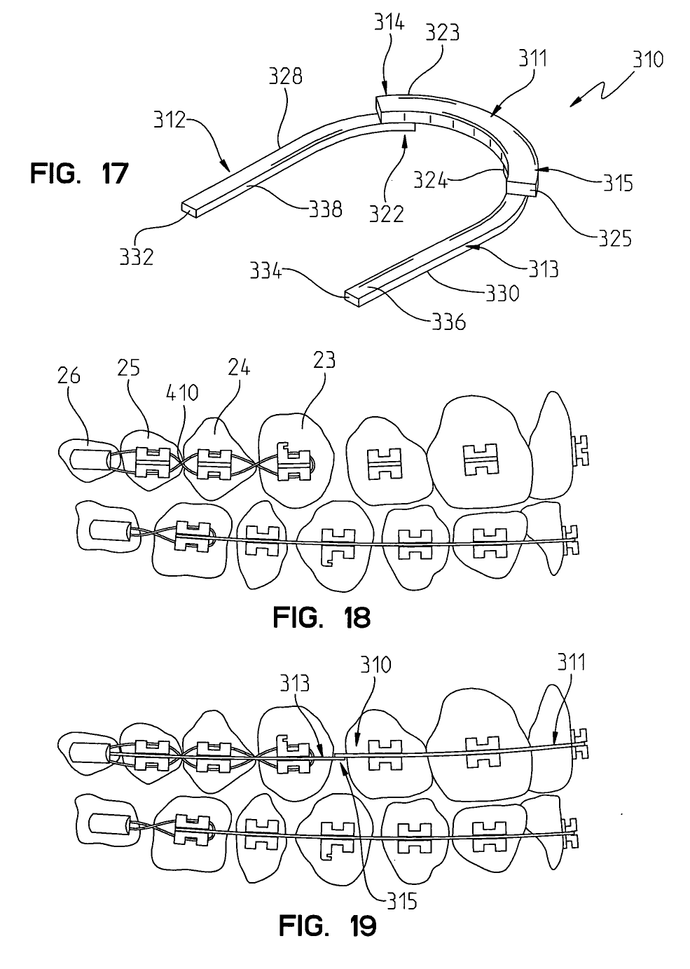

As shown in FIG. 18, a figure-8 steel ligature 410 (size 0.010) is placed around the brackets of the canines 23, premolars 24, 25 and molars underneath posterior portion 313 of the archwire 310, FIG. 19 in order to avoid the opening of spaces between those teeth. As shown in FIG. 20, an elastic chain 76 is then placed over the archwire 310, from canine to canine, in order to produce a class I distalizing force that retracts the incisors 21, 22. O ring ties are placed on the brackets of the premolars. The brackets used have a slot size of 0.022 inches.

The differential archwire 310 is characterized by an anterior segment 311 whose cross-sectional dimensions are 0.021″×0.025″; two posterior segments 312, 313 whose cross sectional dimension are 0.018″×0.022″; and two intermediate segments whose cross-sectional dimensions are 0.039″×0.025″. The anterior segment occupies the brackets 50, 51 of the incisors, and the posterior segments 312, 313 occupy the brackets of the canines, premolars, and molars. The intermediate segments 314, 315 (FIGS. 17, 19) are disposed in the span between lateral incisor and canine. Preferably, the archwire 310 is made from stainless steel.

The differential archwire 310 has different portions with different features:
(1) The anterior segment 311 preferably has a cross sectional dimensions of 0.021″×0.025″. The anterior segment 311 almost completely fills the slot 54, 56 of the brackets 50, 51 of incisors 21, 22, allowing only 4° of archwire-bracket play. This relative size relationship between the relatively larger cross-sectional area of the anterior section 311 and the slots 54, 56 results in a snug fit of the anterior section 311 with the slots 54, 56. This snug fit permits good control of tip and torque of incisors during the retraction phase. Also, the higher flexural and torsional rigidity of the anterior segment helps to avoid the deflection and the twisting of the wire, improving control of tip and torque of incisors during their retraction.
(2) The two intermediate segments 314, 315 are very rigid because their cross-sectional dimensions are 0.039″×0.025″, which make the intermediate sections 314, 315 the thickest portion of the archwire 310 with the greatest flexural rigidity. The elastic chain 76 is used to retract the incisors and extends across the incisors 21, 22. The elastic chain 76 runs from the left canine 23 to the right canine 23. Hence, the largest concentration of retraction force is exerted on the span of archwire 310 included between the lateral incisor 22 and the canine 23. This is the point where the archwire has greater tendency to deflect. The rigidity of archwire in this critical point prevents the deflection of the archwire, maintaining a correct vertical position of the incisors, thus avoiding the formation of a reverse curve of Spee during incisor retraction. The rigidity of the archwire in this point also contrasts the centripetal component of the elastic chain, and helps to maintain a correct transversal dimension of the dental arches and of the inter-canine distance. Further, the overlap of the anterior 311 and posterior 312, 313 segments places the anterior segment in a position more gingival than the posterior segments, and generates an intrusion force on the incisors. The intrusion force also generates buccal crown torque on the incisors, because the force is applied buccally to the center of resistance of the teeth.
(3) The posterior segments 312, 313 preferably have a cross-sectional dimension of 0.018″×0.022″. The smaller cross-section dimensions allow the posterior segments to slide with low friction along the brackets of canines, premolars and molars. The reduction of the cross-section dimensions causes a reduction of the flexural and torsional rigidity of the posterior segments 312, 313, and as a consequence a reduction of wire-bracket binding (friction) in the event of archwire deflection or torsion by misaligned posterior teeth. This, in turns, makes sliding mechanics and incisor retraction much more efficient and faster.

The intrusion force is applied buccally to the center of resistance of the incisors, and generates a moment that torques the incisor roots palatably. The Moment is equal to the intrusive force multiplied by the distance from the center of resistance of the teeth to the bracket and by the sine of angle ct (FIG. 21), it is important to note that the relative sizes of the anterior segment 311 and the slot 54 of the bracket 51 on the incisor is such that the anterior portion 311 can not rotate within the slot 54. As such, the anterior portion can exert a torquing force on the incisor 21 that permits the incisor 21 to retract translationally (FIG. 22), rather than permitting the incisor to rotate about its center of resistance, point 51 (FIG. 5).

### (B) Clinical Procedures

### (1) Incisor Retraction

The combination of a single force and of a moment is required to obtain a bodily translational movement of a tooth such as incisor 21 in FIG. 22 The ideal moment to force ratio (M/F ratio) is 10. As shown in FIG. 22, this translational movement comprises the tooth moving in a “straight line” direction as shown in the two positions of tooth 21, 21′ in FIG. 22, where both the root and crown of the tooth move in a direction indicated by arrow TM of FIG. 22. This straight line movement is in contrast to the rotational movement that moves the tooth in a direction opposite to that indicated by arrow BF.

In the case of the bodily retraction of the incisors, the retracting Class I force is exerted on the tooth 21 by the elastic power chain 76 that is stretched across the anterior portion of the dental arch from canine to canine. The moment is generated by the interaction of the edges of the archwire 311 with the slot walls 54 of the brackets 50 of the incisors. The archwire 311 must engage the slot walls 54 before any torque is transmitted to the roots of the incisors.

If no force were exerted by the interaction of archwire 311 and bracket 50 in a direction indicated by arrow BF, the force exerted by the power chain would move the incisors 21 in a rotational direction that was opposite to the direction indicated by arrow BF. Similarly, if the moment exerted by anterior section 311 is not large enough to balance the Class I force exerted by the power chain, the incisors would rotate around a center of rotation 51 (FIG. 5) positioned on the apical third of the root (FIG. 5).

If rotational, rather than translational movement occurs, the crown of the incisors 21 drops well below the occlusal plane and impacts the lower incisors. Clinically it becomes impossible to close the space between lateral incisor and canine. Creating a satisfactory moment on the incisors can be achieved by means of a simple activation of the differential archwire.

2. Activation of the differential archwire: the 1.5 mm rule

In a 0.022″×0.028″ slot, the theoretical wire-bracket play values are the following:

0.017×0.022 wire: 17°

0.018×0.022 wire: 14°

0.019×0.025 wire: 10°

0.021×0.025 wire: 4°
Undersized 0.021″×0.025″ wire in an oversized 0.022″ slot: 8°

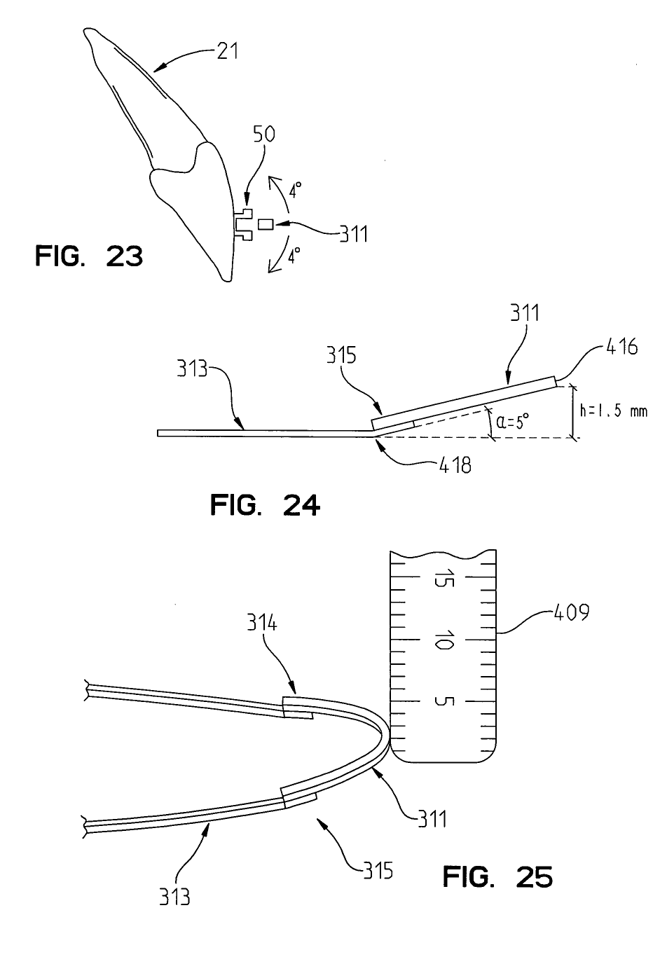

If we consider manufacturing tolerances, it can happen that a 0.021″×25″ wire actually is 0.020″×025″, and that a 0.022″×028″ slot actually is 0.023″×028″ in dimension. In this case of an undersized wire in an oversized slot, the wire-bracket play can go up to 8° even with the 021″×025″ wire; 4° of play are in one direction, and 4° of play are in the other direction as shown in FIG. 23. Because of this inherent 4° of play in this example, we should place at least about 5° of active torque in the archwire, before the edges of the archwire 311 contact the slot walls 54 and torque is transmitted to the roots of the incisors 21.

Clinically we can generate 5° of active torque by placing a 2^{nd} order V bend just distally to the intermediate segments 314, 315 of the differential archwire 310. The 5° V bend is utilized in the majority of the clinical cases. When a 5° V bend 418 is placed, if the archwire lies flat on a table, the most anterior point 416 of the anterior segment of the archwire 310 is 1.5 mm away from the table as illustrated by the ruler 409 and in FIG. 25.

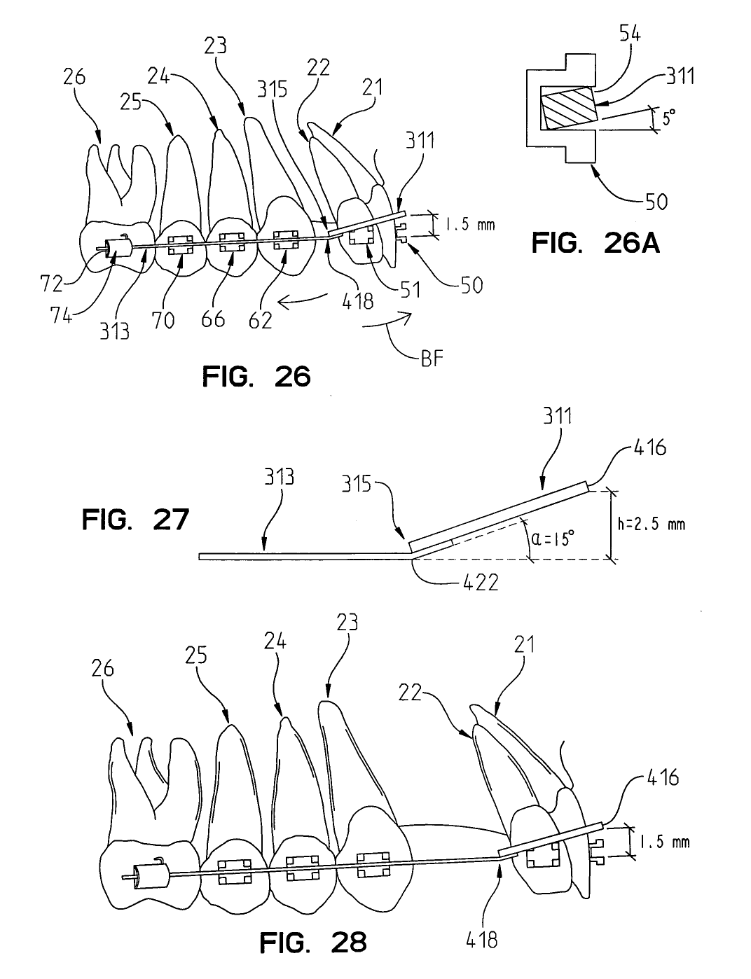

As best shown in FIG. 26, the V bend 418 placed just distally to the intermediate segments 314, 315 of the differential archwire produces:—a buccal crown moment on the incisors
a tip-back moment on the canine crown

The incisor palatal root torque represents the moment needed to obtain bodily movement of the incisors. The tip back moment on the canine contrasts the mesial force of the power chain, and increases the anchorage of the canine 23. The canine is a tooth with a large periodontal area, that can withstand tip back moments and can work like a good abutment for class I forces. There are some clinical situations where a greater buccal crown torque is required on the incisors 21, 22:
1. One situation where a greater buccal crown torque is required is if torque is lost during incisor 21, 22 retraction, and incisors 21, 22 become more vertical and extruded. In this case the class I force exerted by the elastic chain must be reduced (using a longer piece of elastic chain), and the buccal crown torque moment must be increased (such as by using a 15° V bend 422 as shown in FIG. 27, instead of the 5 V-bend 418 shown in FIGS. 24-26.): the result is an increase in the M/F ratio on the incisors.
2. Another situation involves long roots. In the presence of long roots. more incisor torque is required because the center of resistance of the tooth is more apical, thus requiring a greater angle such as 15 bend 422.
3. A third situation involves the treatment of adult patients, where the bone is more dense, and hence, more torque is required.
4. The Applicant has also found that brachifacial patients usually need more incisor torque than dolicifacial patients.
5. Another factor that influences the degree of V-bend desired is the position of brackets 50, 51. Brackets 50, 51 positioned more gingivally (closer to the gum) produce less torque than brackets positioned more incisally. More active torque is then required on the archwire 310, when the brackets 50, 51 are positioned more gingivally.
6. Bracket prescription is another factor, as many different bracket prescriptions exist, with different values of torque.

In these clinical situations the need for more incisor torque appears evident when the space between lateral incisors and canines is almost completely closed (only 2-3 mm of space is left). Upper incisors have not been completely retracted, and there is not enough clearance between upper and lower incisors. At this point a 15° V bend is recommended as shown in FIG. 27. If the archwire lies flat on a table, the most anterior point of the archwire is 2.5 mm away from the table as illustrated in FIG. 27.

In this situation also the lower arch should be checked to make sure that the Curve of Spee is completely leveled. In deep bite cases the bonding of the lower second molar is suggested strongly, because it makes leveling the Curve of Spee and bite opening much more efficient.

### C. Clinical Recommendation:

When the incisor retraction is started, and the incisors 21, 22 are significantly spatially separated from the canines 23, the practitioner should employ a small V bend 418 activation of about 5°, or where the extreme anterior end 416 of anterior segment 311 is about 1.5 mm elevated from the plane of the lower surface of the posterior 313, 314 sections, as shown in FIG. 28.

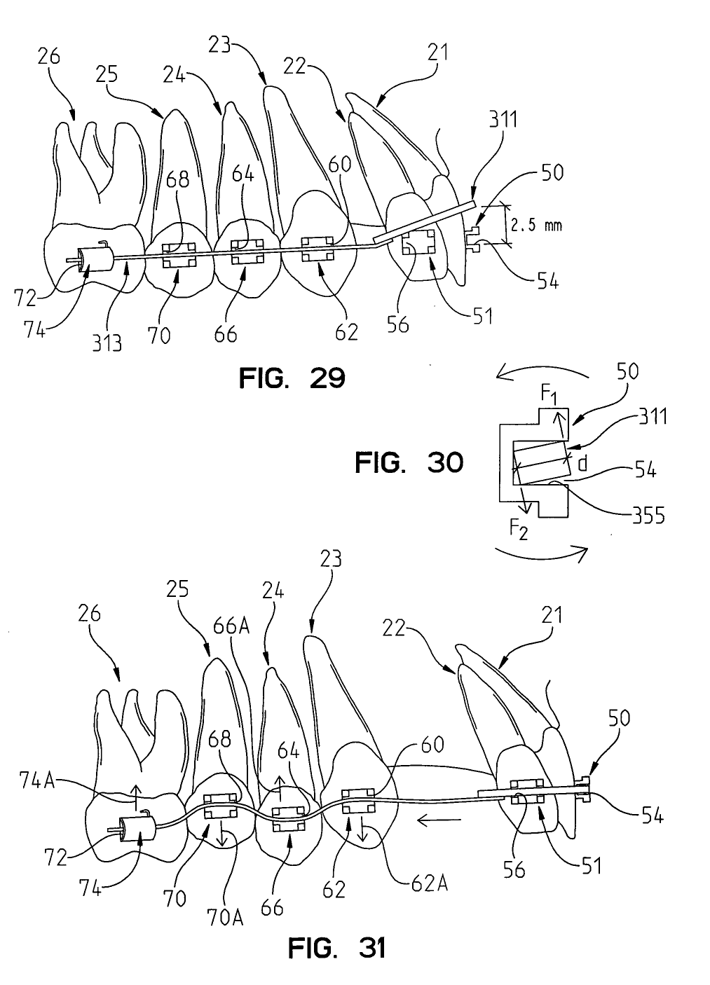

When the space is almost completely closed (e.g. 2-3 mm of space is left between lateral incisor 22 and canine 23), and only in those clinical situations where more torque is required, a larger, 2.5 mm, V bend activation can then be made, as shown in FIGS. 27 and 29.

Large V bend activations (e.g. 2.5 mm, 15°) should never be placed at the beginning of the incisor retraction phase, when incisors are highly spatially separated from the canines as shown in FIG. 28. If a larger V-bend activation were made at this phase, the V bend would work like an off-center bend that produces a larger moment on the incisors and extrudes them (cantilever effect). This cantilever effect must be avoided, because the extrusion of the incisors will likely produce an increase of the incisor overbite, and prematurities on the incisors that make impossible the incisor retraction.

Large V bend activations should only be placed in the archwire 310 at the end of the incisor retraction phase, when only about 2-3 mm of space is present between lateral incisor 22 and canine 23 as shown in FIG. 29. When the lateral incisor 22 and canine 23 are only separated by about 2-3 mm, the V bend 422 works like a centered V bend, increasing torque on the incisors 21, 22 and increasing tip-back on the canine 23, and no vertical component is present since no extrusion force is present on the incisors 21, 22.

After the space between lateral incisor 22 and canine 23 has been closed, the V bend is left in place for 1-2 appointments, to obtain complete palatal root torque expression. Then it is removed. At this point, usually a 0.019″×0.025″ beta-titanium archwire is inserted for the finishing-detailing phase. From the Applicant's clinical experience, an activation of 1.5 mm is enough to generate a bodily incisor movement in the majority of clinical cases, if the power chain is correctly utilized. It appears evident that second order V bends 418, 422 (FIGS. 24 through 30) are utilized in the orthodontic technique of the differential archwire to increase palatal root torque during incisor retraction. When 2^{nd} order V bends are utilized, as previously described, the archwire is deflected and wire-bracket binding phenomena tend to occur on the canine bracket 62 (that is the bracket closest to the V bend).

Wire-bracket binding can be kept at low levels by utilizing posterior segments 312, 313 with lower cross-section size and hence, reduced rigidity. Reduced cross section size and reduced rigidity improves sliding mechanics and efficiency of incisor retraction even when V bends are utilized, as discussed in paragraphs 96 through 114.

Also, when 2^{nd} order V bends are utilized in the span of wire included between lateral incisor and canine, the archwire is deflected and the canine bracket 62 tends to bite into the wire, especially if the wire has a round cross-section shape. For this reason, the preferred cross-section shape is rectangular with the long side of the rectangle parallel to the horizontal plane, as discussed in paragraphs 118 and 128.

### D. Power Chain, the Class I Retracting Force: the 7 mm Rule

The power chain 76 (FIG. 20) is the preferred method of producing a class I force, because it is very easy and quick to insert and remove. Also, it is well tollerated by the patients because no hooks and no loops are required. Further, the power chain 76 is less visible than closing loops, that is appreciated by the adult patients when esthetic brackets are used.

Additionally, a power chain works like an intermittent force. Force is almost zero after 48-72 hours. Intermittent forces have been shown to be better in terms of reducing root resorption, because they give time to cementoblasts to repair possible root damages during the time interval between appointments.

Also, a power chain is versatile in its clinical use, because the orthodontist at each appointment can choose to:
1. Change the force levels, by changing the length of the elastic chain;
2. Change the frequency of the force, by changing the time interval between appointments (4 or 5 weeks).

If excessive tipping (rotational, rather than translational movement) of incisors occurs, the orthodontist can choose not to change the power chain for one appointment, and let that the moment generated by the elastic memory of the archwire torques the incisor roots towards the palate.

Following a very simple rule allows the orthodontist to generate predictable force levels with the power chain. In fact, the force generated by the power chain is directly proportional to the amount of stretching of the chain. The amount of stretching of the chain, in turns, depends on the distance between brackets. So, clinically, we should measure the distance between brackets (not between teeth, because the tooth size is different in different patients), to decide how many O-rings of the elastic chain to use.

The force generated by the elastic chain can be kept in the range of force of 250-300 gr, by following this simple rule:
if the space between the bracket 51 of the lateral incisor 22 and bracket 62 of the canine 23 is 7 mm or more, one extra O-ring should be placed in the span between lateral incisor 22 and canine 23;
if the space between the bracket 51 of the lateral incisor 22 and bracket 62 of the canine 23 is 6.5 mm or less, one O-ring should be placed for each bracket. In this case, only the mesial wings of the canine bracket should be tied, to prevent mesial rotation of the canine 23.

### E. When More Torque is Required on the Central Incisors Only

Sometimes, during incisor retraction, more torque is required only on the central incisors. This happens because the roots of the central incisors 21 are longer than the roots of the lateral incisors 22, hence the center of resistance of the central incisors is more apical. In these clinical situations tipically the central incisors 21 become more vertical and extruded and hit the brackets of the lower incisors.

Extra torque can be placed easily only on the central incisors by twisting the archwire corresponding to the central incisors. A 5°, 3^{rd} order bend is placed on the archwire between lateral 22 and central 21 incisors. The same is done between the lateral and central incisor in the controlateral side.

What is claimed is:

1. An archwire for use in an orthodontic appliance of the type that includes brackets attached to a surface of at least one tooth, the archwire comprising:
an anterior portion for engaging at least one bracket of at least one anteriorly disposed tooth in a patient's mouth, the anterior portion including a relatively larger cross sectional area, a first end portion and a second end portion
a first posterior portion for engaging at least one bracket of at least one posteriorly disposed tooth in a patient's mouth, the first posterior portion including a proximal end portion fixedly coupled to the first end portion of the anterior portion; and a second end; and
a second posterior portion for engaging at least one bracket of at least one posteriorly disposed tooth in a patient's mouth, the second posterior portion including a proximal end portion fixedly coupled to the second end portion of the anterior portion of the second end,
wherein the first and second posterior portion each have a relatively smaller cross sectional area than the relatively larger cross sectional area of the anterior portion.

2. The archwire of claim 1 wherein the cross sectional areas of each of the anterior portion, first posterior portion and second posterior portion include a width dimension extending in a direction generally perpendicular to a plane of a surface of a tooth to which a bracket is attached, and a height dimension extending in a direction generally parallel with a plane of a surface of a tooth to which a bracket is attached, wherein the width dimension of the cross sectional areas of each of the anterior portion, first posterior portion and second posterior portion is greater than the height dimension of the corresponding anterior portion, first posterior portion and second posterior portion.

3. The archwire of claim 2 further comprising a first intermediate portion wherein the first posterior portion is fixedly coupled to the anterior portion, and a second intermediate portion wherein the second posterior portion is fixedly coupled to the anterior portion.

4. The archwire of claim 3 wherein the anterior portion includes a first end portion and a second end portion, and each of the first and second posterior portions include a first end portion and a second end portion, and
the first end portion of the anterior portion is overlapingly fixedly coupled to the proximal end of the first posterior portion to form the first intermediate portion, and the second end portion of the anterior portion is fixedly overlapingly coupled to the proximal end of the second posterior portion to form the second intermediate portion,
the first and second intermediate portions each having a larger cross sectional area than any one of the first anterior section, first posterior section and second posterior section.

5. The archwire of claim 4 wherein the anterior portion has a greater flexural rigidity than either of the first and second posterior portions, and either of the first and second intermediate portion has a greater flexural rigidity than the anterior portion.

6. The archwire of claim 4 wherein each of the anterior portion, first posterior portion and second posterior portion have a cross sectional shape chosen from a group consisting of quadrilaterals, pentilaterals, hexilaterals, septilaterals and octilaterals.

7. The archwire of claim 4 wherein each of the anterior portion, first posterior portion and second posterior portion have a generally rectangular cross sectional shape.

8. The archwire of claim 4 wherein the cross sectional area of the first and second posterior portions is sufficiently small in relation to the brackets to permit the first and second posterior portions of the archwire to slidably move relative to the bracket with only minimal frictional resistance.

9. The archwire of claim 8 wherein the cross sectional area of the anterior portion is sufficiently large relative to the brackets to induce a torquing force on a tooth to which the bracket is attached, to influence the inclination of a tooth and to not be slidably movable relative to the bracket without overcoming a greater amount of frictional resistance than that which exists between the first or second posterior portion and the bracket.

10. The archwire of claim 9 wherein the archwire includes a bend portion positioned on at least one of the first and second posterior portions, the bend portion having an angle for enabling the anterior portion to exert an active torquing force on at least one tooth.

11. The archwire of claim 10 where the bend portion is bent at an angle of between about 4° and 25°.

12. The archwire of claim 2 wherein the cross sectional area of the anterior portion is sufficiently large relative to the brackets to enable the anterior portion to induce a torqueing force on a tooth to which the bracket is attached, to influence the inclination of the tooth and to not be slidably movable relative to the bracket without overcoming a greater amount of frictional resistance than that which exists between the first or second posterior portion and the bracket.

13. The archwire of claim 3 wherein the anterior portion includes a first end portion and a second end portion, and each of the first and second posterior portions include a first end portion and a second end portion, and the first end portion of the anterior portion is overlapping fixedly coupled to the proximal end of the first posterior portion to form the first intermediate portion, and the second end portion of the anterior portion is fixedly overlappingly coupled to the proximal end the second posterior portion to form the second intermediate portion.

14. The archwire of claim 13 wherein the first and second intermediate portions each have a larger cross sectional area and greater flexural rigidity than any of the anterior portion, first posterior portion and second posterior portion.

15. The archwire of claim 3 wherein the anterior portion has a greater flexural rigidity than either of the first and second posterior portions, and the intermediate portion has a greater flexural rigidity than the anterior portion.

16. The archwire of claim 2 wherein the cross sectional area of the first and second posterior portions is sufficiently small relative to the brackets to permit the first and second posterior portions of the archwire to slidably move relative to the bracket with only minimal frictional resistance.

17. The archwire of claim 2 wherein the archwire includes a bend portion positioned on at least one of the first and second posterior portions, the bend portion having an angle for enabling the anterior portion to exert an active torquing force on at least one tooth.

18. The archwire of claim 17 wherein the bend portion is bent at an angle of between about 4° and 25°.

19. The archwire of claim 2 wherein the archwire includes an accentuated curve of Spee.

20. The archwire of claim 2 wherein the anterior portion is disposed in a plane that is generally parallel to, but not coplanar with a plane in which the first and second posterior portions are disposed.

21. The archwire of claim 2 wherein the archwire includes a step like first intermediate portion where the anterior portion meets the first intermediate portion and a step like portion, the step portion serving to place the anterior portion in the plane disposed parallel to and more gingivally of the first and second posterior portions.

22. The archwire of claim 2 wherein the anterior portion has a greater flexural rigidity than either of the first and second posterior portion.

23. The archwire of claim 22 wherein the anterior portion is not coplanar with either of the first and second posterior portions.

24. The archwire of claim 1 wherein the anterior portion has a greater flexural rigidity than either of the first and second posterior portion.

25. The archwire of claim 24 wherein the anterior portion is non co-planar with either of the first and second posterior portions.
